(19) United States
(12) Patent Application Publication
(10) Pub. No.: US 2009/0007696 A1
(43) Pub. Date: Jan. 8, 2009

(54) Strain gauge type sensor

(75) Inventor: Hideo Morimoto, Yamatokoriyama-shi (JP)

Correspondence Address: OSHA LIANG L.L.P., TWO HOUSTON CENTER, 909 FANNIN, SUITE 3500, HOUSTON, TX, 77010, US

(73) Assignee: NITTA CORPORATION, Osaka (JP)

(21) Appl. No.: 11/825,314

(22) Filed: Jul. 5, 2007

(51) Int. Cl. G01L 1/22; G01L 5/16

(52) U.S. Cl. 73/862.045

(57) ABSTRACT

On a strain generation body 31 of a strain gauge type sensor 1, a strain gauge G is disposed for detecting a force externally applied, and a conductive first land 71b is formed. A conductive second land 81b is formed near an end of a flexible substrate 41 laid over a surface of the strain generation body 31 on which the strain gauge G is disposed. A substrate end portion of the flexible substrate 41 near the second land 81b is disposed above the first land 71b of the strain generation body 31. The first land 71b, the second land 81b, and a lead wire L are fixed to each other by soldering so that the lead wire L is electrically connected to the strain gauge G.

### BACKGROUND OF THE INVENTION

1. Field of the Invention

The present invention relates to a strain gauge type sensor that detects by using a strain gauge a force externally applied.

2. Description of Related Art

Japanese Patent Unexamined Publication No. 2005-300465 discloses a strain gauge type sensor capable of measuring a force or moment externally applied. The strain gauge type sensor includes a pair of disk-shaped members opposed to each other, and four ring-structure strain generation bodies, as plate members, interconnecting the disk-shaped members. The strain generation bodies are arranged around the center of the strain gauge type sensor at angular intervals of 90 degrees. The strain generation bodies are disposed at the same distance from the center. A strain gauge is attached to a surface of each ring-structure strain generation body. By being thus constructed, the strain gauge type sensor can measure a force or moment applied between the opposed disk-shaped members.

In general, the strain gauge type sensor disclosed in the above publication is designed into a small size. In the small-size sensor, when a land to be electrically connected to a strain gauge is formed on the surface of the strain generation body on which the strain gauge is disposed, the area of the land is restricted. Therefore, the area of the land is very small, and this makes it hard to attach a lead wire to the land.

### SUMMARY OF THE INVENTION

An object of the present invention is to provide a strain gauge type sensor wherein a lead wire can easily be attached.

According to the present invention, a strain gauge type sensor is provided that comprises a first plate-like member on which a strain gauge is disposed that detects a force externally applied; a second plate-like member put in layers with the first plate-like member over a surface of the first plate-like member on which the strain gauge is disposed; a conductive first connection region formed on the first plate-like member; and a conductive second connection region formed near an end of the second plate-like member. The first connection region, the second connection region, and a lead wire electrically connected to the strain gauge, are fixed by a conductive connection material in a state in which an end portion of the second plate-like member near the second connection region is disposed above the first connection region of the first plate-like member.

According to the above feature, not only the first connection region but also the second connection region can be used for lands to which the lead wire is attached. This increases the effective land area. Therefore, a strain gauge type sensor is obtained wherein the lead wire can easily be attached.

In the strain gauge type sensor of the present invention, it is preferable that the first plate-like member comprises a pair of first connection regions, and the strain gauge disposed between the pair of first connection regions, second connection regions are formed near both ends of the second plate-like member, and the strain gauge is covered by the second plate-like member by fixing end portions of the second plate-like member near the respective second connection regions, on the pair of first connection regions of the first plate-like member, respectively.

According to the above feature, because the strain gauge is covered by the second plate-like member, the strain gauge is prevented from coming into contact with a hand or the like in handling the strain gauge type sensor. This prevents damage of the strain gauge and deterioration of characteristics due to adhesion of impurities.

In the strain gauge type sensor of the present invention, it is preferable that a cutout is formed at an end of the second plate-like member, and the second connection region is formed around the cutout.

According to the above feature, the first connection region can widely be used. In addition, when soldering, solder is hard to flow out of the first connection region. This realizes stable soldering.

In the strain gauge type sensor of the present invention, it is preferable that the second connection region is smaller than the first connection region in heat capacity.

According to the above feature, when the first connection region is relatively high in heat capacity, by making the second connection region of a material low in heat capacity, the wettability with solder is improved when the first connection region, the second connection region, and the lead wire, are fixed to each other. This makes it easier to attach the lead wire.

### BRIEF DESCRIPTION OF THE DRAWINGS

Other and further objects, features and advantages of the invention will appear more fully from the following description taken in connection with the accompanying drawings in which:

FIG. 1 is a perspective view of a strain gauge type sensor according to a first embodiment of the present invention;

FIG. 2(a) is an upper view of the strain gauge type sensor of FIG. 1, and FIG. 2(b) is a side view of the strain gauge type sensor of FIG. 1;

FIG. 3 shows a strain generation body in a region corresponding to A in FIG. 2(b);

FIG. 4 shows a flexible substrate of FIG. 1;

FIG. 5 shows the strain generation body, the flexible substrate, and portions for attaching lead wires, in the region A of FIG. 2(b);

FIG. 6 is a B-B′ sectional view of FIG. 5;

FIG. 7 is a sectional view, at a position corresponding to the B-B′ section of FIG. 5, showing a portion of a strain gauge type sensor according to a modification of the first embodiment, where a strain generation body, a flexible substrate, and a lead wire are attached to each other;

FIG. 8(a) is an upper view of a strain gauge type sensor according to a second embodiment of the present invention, and FIG. 8(b) is a C-C′ sectional view of FIG. 8(a);

FIG. 9 is an enlarged sectional view of a region D in FIG. 8(b); and

FIG. 10 is a general circuit diagram showing a bridge circuit constructed in the strain gauge type sensor of FIG. 8(a).

### DESCRIPTION OF THE PREFERRED EMBODIMENTS

Hereinafter, preferred embodiments of the present invention will be described with reference to the drawings.

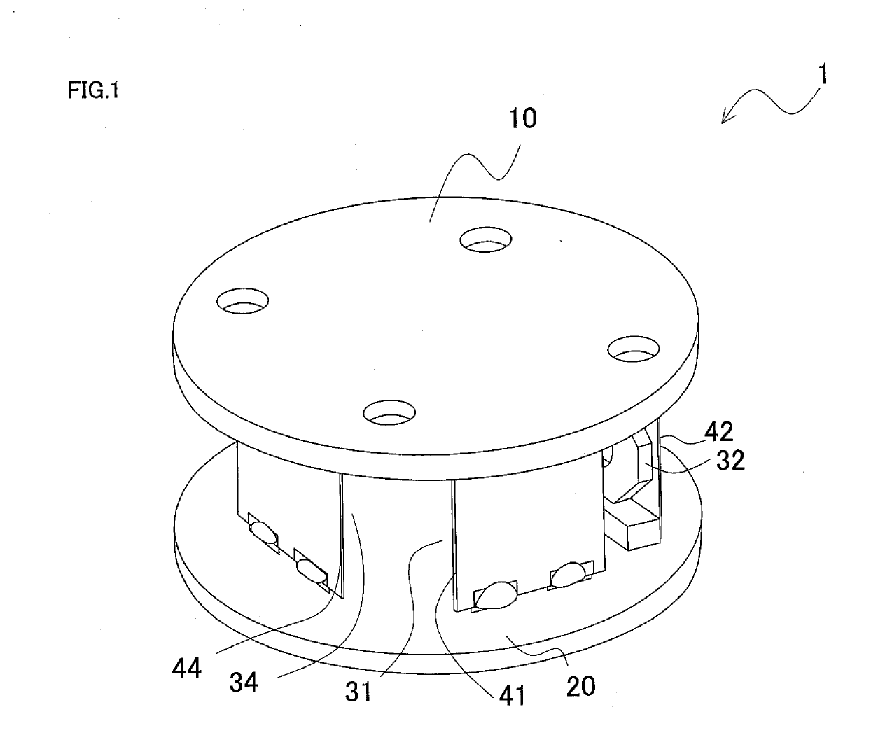

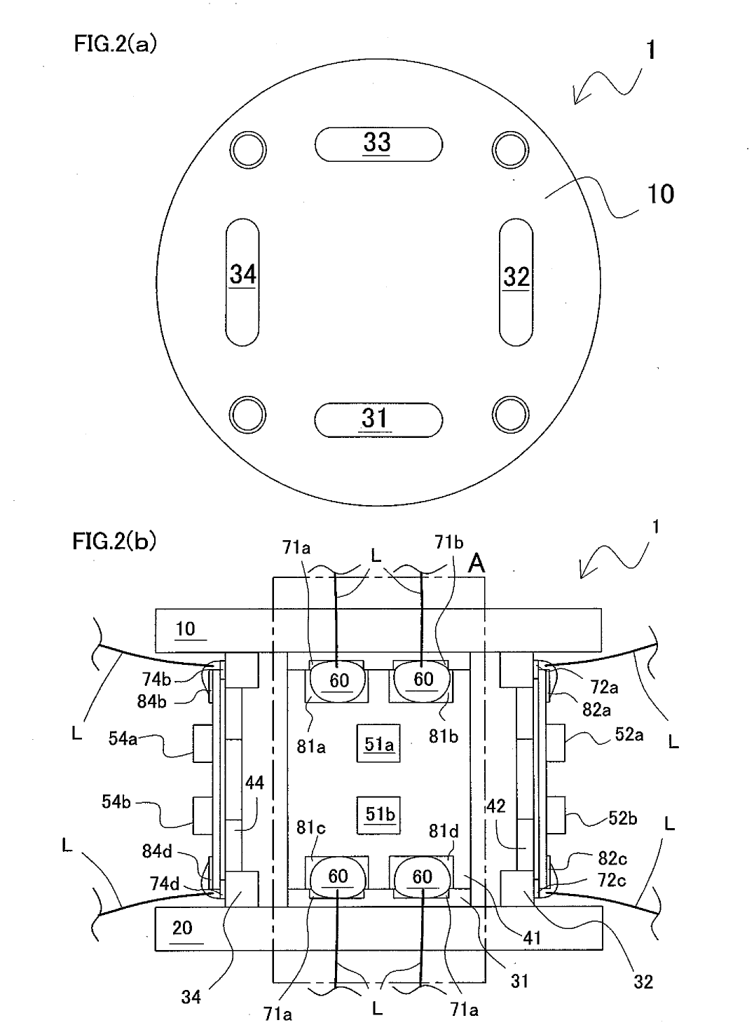

First, a general construction of a strain gauge type sensor according to a first embodiment of the present invention will be described with reference to FIGS. 1, 2(a), and 2(b). FIG. 1 is a perspective view of the strain gauge type sensor according to the first embodiment. FIG. 2(a) is an upper view of the strain gauge type sensor of FIG. 1. FIG. 2(b) is a side view of the same.

Here will be described an embodiment in which the strain gauge type sensor 1 is used as a force sensor.

As shown in FIG. 1, 2(a), and 2(b), the strain gauge type sensor 1 includes a pair of upper and lower flanges 10 and 20 opposed to each other, and four strain generation bodies 31 to 34 interconnecting the upper and lower flanges 10 and 20. The strain gauge type sensor 1 is for measuring a multiaxial force or moment applied between the upper and lower flanges 10 and 20. Each of the upper and lower flanges 10 and 20 is formed into a disk-shaped plate. The upper and lower flanges 10 and 20 are disposed parallel to each other. Each of the upper and lower flanges 10 and 20 is made of a metallic material such as SUS or aluminum. As will be described later, a strain gauge is disposed on a surface of each of the strain generation bodies 31 to 34.

The lower flange 20 of the strain gauge type sensor 1 constructed as described above is fixed, and a part, a device, or the like, is attached to the upper flange 10. In this state, when a force is externally applied to the part, the device, or the like, the force is transmitted via the upper flange 10 to the strain generation bodies 31 to 34 so that a strain is generated at each strain gauge portion. The strain generated depends on the intensity and direction of the force applied. Thus, by detecting a change in the resistance of each strain gauge, six components in total can accurately be detected, that is, force components on three axes perpendicular to each other, including the central axis of the strain gauge type sensor 1 as one axis, and moment components around the respective axes. The principle of the detection is described in Japanese Patent Unexamined Publication No. 2005-300465, and therefore here will be omitted a detailed description thereof.

The strain generation bodies 31 to 34 are arranged around the central axis of the strain gauge type sensor 1 at angular intervals of 90 degrees. The strain generation bodies 31 to 34 are disposed at the same distance from the central axis. Flexible substrates 41 to 44 are fixed to the respective strain generation bodies 31 to 34 by soldering. As shown in FIG. 2(b), lead wires L are connected to the strain gauge type sensor 1 though the lead wires L are omitted in FIG. 1.

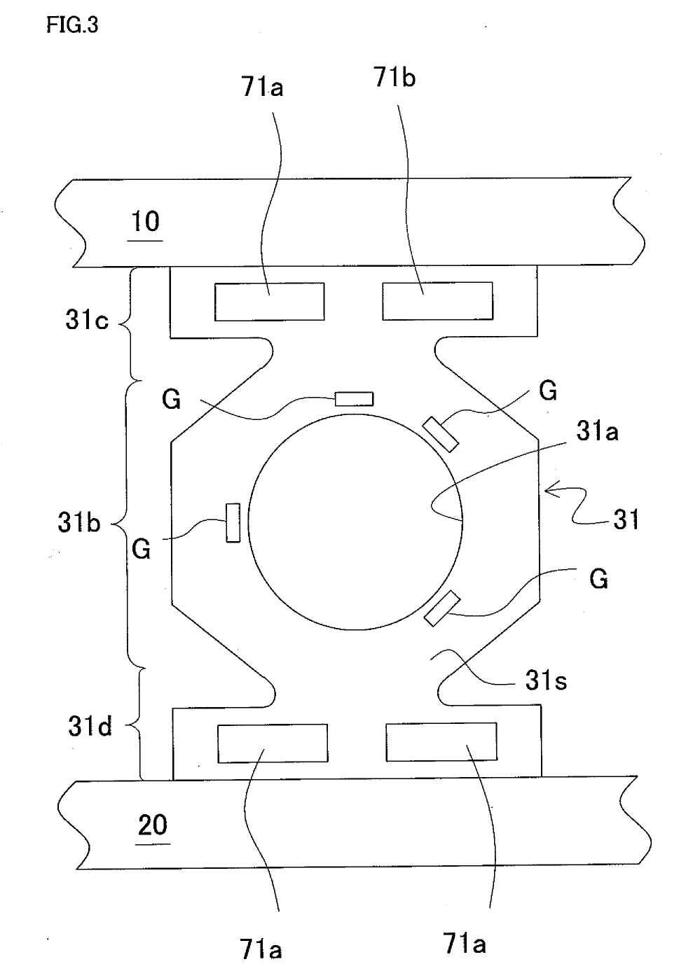

The strain generation body 31 is constructed as shown in FIG. 3. FIG. 3 shows the strain generation body 31 in a region corresponding to A in FIGS. 2(a) and 2(b). The strain generation bodies 32 to 34 have the same construction as the strain generation body 31, and therefore the description of the strain generation bodies 32 to 34 will be omitted. As shown in FIG. 3, the strain generation body 31 is united with the upper and lower flanges 10 and 20. More specifically, not-shown engage portions are formed at ends of the strain generation body 31 and at the faces of the upper and lower flanges 10 and 20 facing the strain generation body 31. The strain generation body 31 is fixed to the upper and lower flanges 10 and 20 by engagement, and then secured to the upper and lower flanges 10 and 20 by welding, for example, by electron beam welding, by which no residual stress remains. Thus, a force externally applied to the upper or lower flange 10 or 20 is efficiently transmitted to the strain generation body 31 to generate a strain.

The strain generation body 31 includes a central portion 31b and lead wire connection portions 31c and 31d near the respective upper and lower flanges 10 and 20. The central portion 31b is ring-shaped and has a substantially octagonal outer shape. A circular through hole 31a is formed at the center of the central portion 31b. Each of the lead wire connection portions 31c and 31d has its width substantially equal to the maximum width of the central portion 31b; and its thickness larger than the thickness of the central portion 31b, as shown in FIG. 2(b). The outer shape of the central portion 31b is not limited to such an octagon. It may be formed into another polygon or a circle.

The strain generation body 31 is made of a metallic material such as SUS or aluminum. The strain generation body 31 has on its surface an insulating film 31s made of silicon oxide or the like. The insulating film 31s is formed on the base body of the strain generation body 31 planarized in its whole area, by a thin-film formation technique such as sputtering. In a modification, such an insulating film 31s may be formed by plating with alumite or the like.

On the lead wire connection portions 31c and 31d of the strain generation body 31, conductive first lands 71a to 71d are formed on the surface of the insulating film 31s. In this embodiment, first lands 71a and 71b, which are paired with each other, are formed on the lead wire connection portion 31c near the upper flange 10; and first lands 71c and 71d, which are paired with each other, are formed on the lead wire connection portion 31d near the lower flange 20. Each of the first lands 71a to 71d is made of a metallic thin film of nickel. It is formed on the surface of the insulating film 31s by sputtering, photolithography, and so on. Nickel is good in the bondability with the strain generation body 31 made of SUS or the like, and good in the wettability with solder. Although nickel is used for the first lands 71a to 71d in this embodiment, gold, silver, cupper, chromium, or solder, can be used other than nickel.

On the surface of the insulating film 31s of the central portion 31b, four strain gauges G are disposed for detecting a force externally applied. The strain gauges are disposed between the pairs of first lands 71a and 71b; and 71c and 71d. For each strain gauge G used is a metallic foil strain gauge or a metallic wire strain gauge. Such a strain gauge G is a kind of resistor. It is used in a state of being attached to where strain is generated. Because the resistance value of the strain gauge G changes in accordance with the strain generated, the strain epsilon can be measured. In general, the strain gauge G has a proportional characteristic in which its resistance value increases to the strain epsilon due to tension while its resistance value decreases to the strain epsilon due to compression. Normally, the strain gauge G is used within an elastic region of the material in which the stress sigma is proportional to the strain epsilon. Thus, in this embodiment, the stain gauges G are used within an elastic region of the strain generation body 31. Each strain gauge G is formed on the insulating film 31s in the form of a metallic thin film such as chromium, advance, constantan, a nichrome-base alloy, or chromium oxide, by using a thin-film formation technique such as photolithography.

The strain gauges G constitute a bridge circuit on the surface of the insulating film 31s so that strain generated in the strain generation body 31 can be detected as an electric signal with high sensitivity. The bridge circuit is also formed by sputtering, photolithography, and so on. The strain gauges G are electrically connected to the first lands 71a to 71d. In order to supply a constant voltage or a constant current to each strain gauge G and receive an electric signal from the strain gauge C, as will be described later, a lead wire L is connected to each of the first lands 71a to 71d by soldering.

In a modification, the surfaces of bridge wiring portions other than the strain gauges G, and the first lands 71a to 71d, may be covered with a highly conductive metallic thin film such as gold, silver, copper, or aluminum, by a method such as sputtering. When such a highly conductive film is provided, the resistances in the bridge circuit concentrate in each strain gauge G so that the resistance value of each bridge wiring portion relatively decreases. Therefore, there is an advantage that the interference by the multiaxial force decreases.

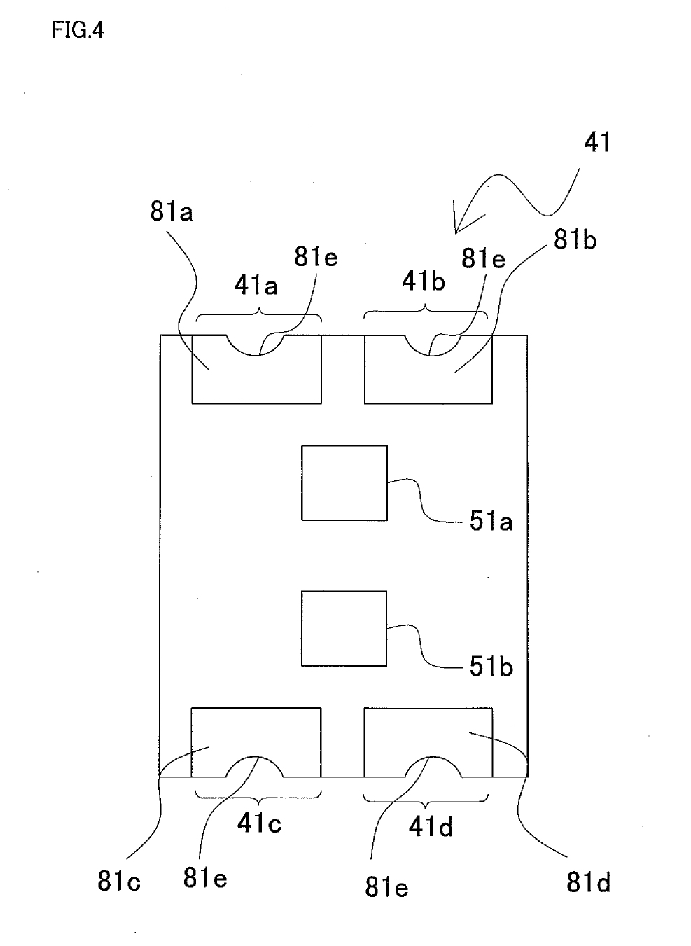

The flexible substrate 41 fixedly disposed on the strain generation body 31 is constructed as shown in FIG. 4. The flexible substrates 42 to 44 have the same construction as the flexible substrate 41, and therefore the description of the flexible substrates 42 to 44 will be omitted. The flexible substrate 41 is made of a synthetic resin material. As shown in FIG. 4, on a surface of the flexible substrate 41, there are formed conductive second lands 81a and 81b near the upper end, and conductive second lands 81c and 81d near the lower end, for connecting to lead wires L. In this embodiment, each of the second lands 81a to 81d is made of copper. For preventing oxidation, the second lands 81a to 81d may be plated with gold, silver, or solder. The second lands 81a to 81d made of copper are lower in heat capacity than the first lands 71a to 71d made of nickel.

Circular cutouts 81e are formed at the upper and lower ends of the flexible substrate 41. The second lands 81a to 81d are formed around the respective cutouts 81e. The second lands 81a to 81d are formed into the same shape at the corresponding ends of the flexible substrate 41. Portions of the flexible substrate 41 near the respective second lands 81a to 81d are referred to as substrate end portions 41a to 41d.

Surface-mounted OP amplifiers 51a and 51b are disposed in the middle of the flexible substrate 41. In this embodiment, by providing two OP amplifiers, impedance conversion of bridge circuit outputs of two circuits is realized. In general, when the connection length from a strain gauge to the input terminal of an amplifying circuit is long, the influence of noise is apt to be received. In addition, because a lead wire is required to be long, an output error is generated due to a change in the impedance of a conductor caused by bend and stress of the lead wire. For the above reasons, accurate measurement can not be performed. In this embodiment, however, because the OP amplifiers 51a and 51b are installed in the strain gauge type sensor 1, the OP amplifiers 51a and 51b are located near the output terminal of the bridge circuit. This lowers the output impedance, and makes it hard to receive adverse influence of such a long lead wire.

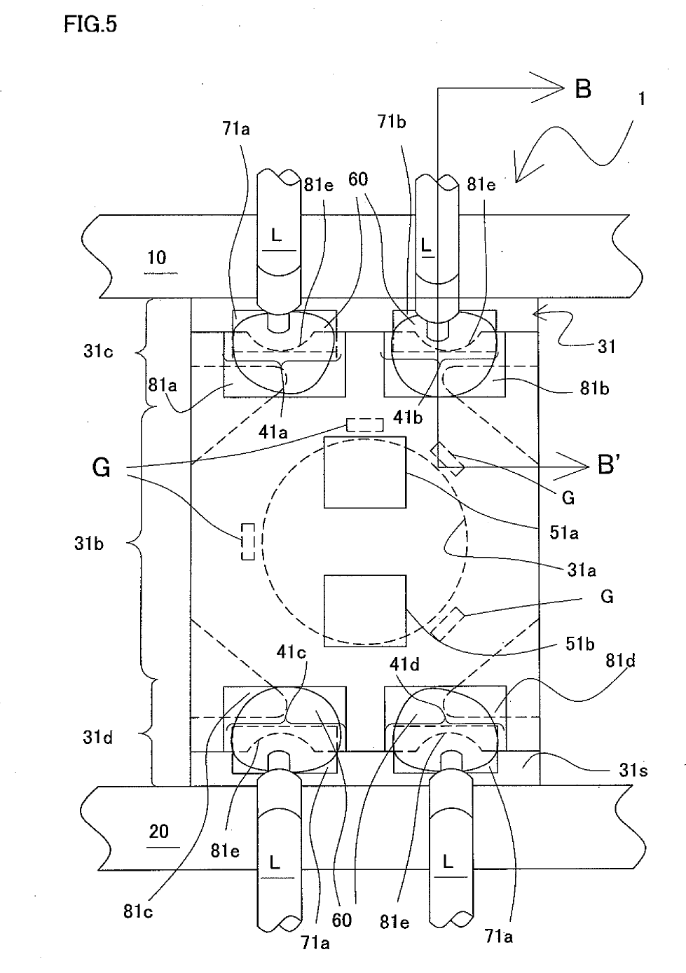

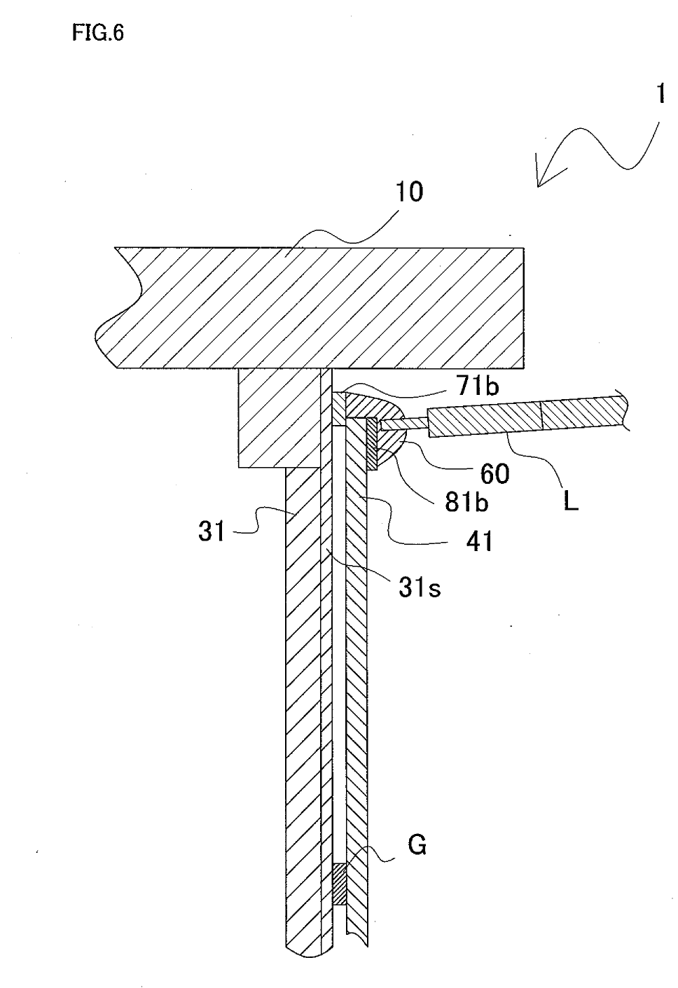

Next, a portion of the strain gauge type sensor 1 where the strain generation body 31, the flexible substrate 41, and a lead wire L are attached to each other, will be described with reference to FIGS. 5 and 6. FIG. 5 shows a region A in FIG. 2(b). FIG. 6 is a B-B′ sectional view of FIG. 5.

As shown in FIG. 5, the substrate end portions 41a and 41b; and 41c and 41d of the flexible substrate 41 near the second lands 81a and 82b; and 81c and 81d are disposed above the pairs of first lands 71a and 71b; and 71c and 71d of the strain generation body 31, respectively. The first lands 71a to 71d and the second lands 81a to 81d and lead wires L are fixed to each other by soldering. Thus, the lead wires L are electrically connected to the respective strain gauges G. In addition, the flexible substrate 41 is mechanically fixed to the strain generation body 31.

By thus attaching the flexible substrate 41 to the strain generation body 31, as shown in FIG. 6, each strain gauge G is covered by the flexible substrate 41 in a side view. Because the strain gauges G and the bridge circuit are formed by a thin-film formation technique, they are apt to be damaged by coming into contact with a hand or the like. In addition, if impurities such as sodium adhering the hand are transferred to such a thin film, this causes a problem that electrical characteristics are deteriorated. In this embodiment, however, because the strain gauges G and the bridge circuit are covered by the flexible substrate 41, the strain gauges G are prevented from coming into contact with a hand or the like when handling the strain gauge type sensor 1. This prevents the deterioration of the characteristics due to damage of the strain gauges G and adhesion of impurities.

Further, as shown in FIG. 6, not only the first lands 71a to 71d but also the second lands 81a to 81d can be used for the lands to which the lead wires L are attached. This increases each effective land area. Therefore, a strain gauge type sensor is obtained wherein each lead wire L can easily be attached.

Further, the cutouts 81e are formed in the respective second lands 81a to 81d and at the portions of the flexible substrate 41 corresponding to the respective second lands 81a to 81d. Therefore, by positioning the first lands 71a to 71d to the respective cutouts 81e, the first lands 71a to 71d can widely be used for soldering. In addition, when soldering, solder is hard to flow out of each of the first lands 71a to 17d. This realizes stable soldering.

Further, the second lands 81a to 81d are lower in heat capacity than the first lands 71a to 17d. Therefore, when the first lands 71a to 17d are relatively high in heat capacity, by making the second lands 81a to 81d of a material low in heat capacity, the wettability with solder is improved when the first lands 71a to 17d, the second lands 81a to 81d, and the lead wires L, are fixed to each other. This makes it easier to attach the lead wires L.

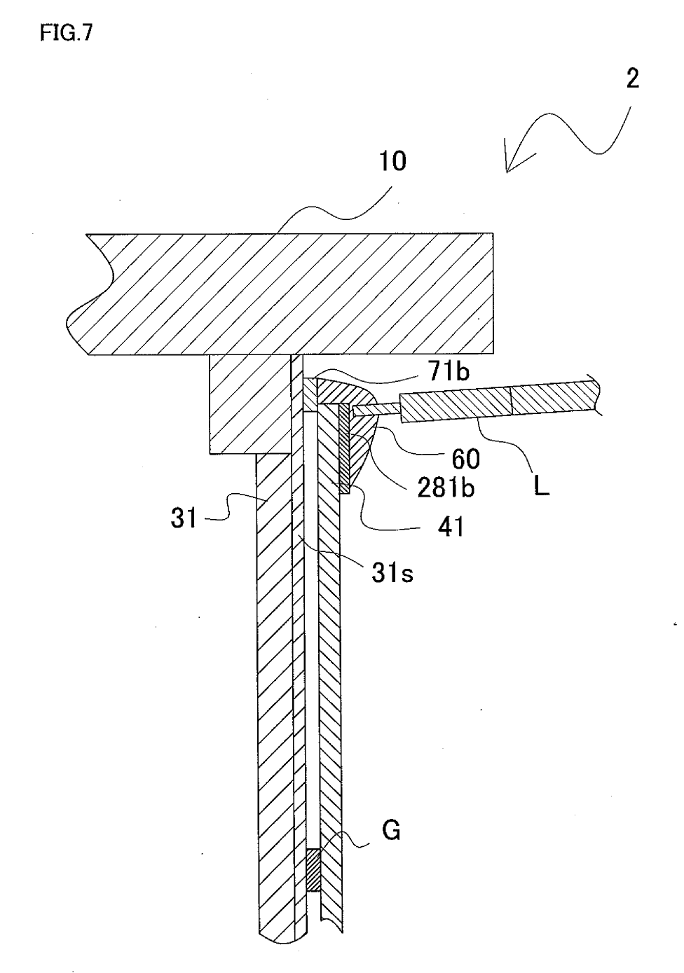

Next, a modification of this embodiment will be described with reference to FIG. 7. FIG. 7 is a sectional view, at a position corresponding to the B-B′ section of FIG. 5, showing a portion of a strain gauge type sensor according to this modification, where a strain generation body 31, a flexible substrate 41, and a lead wire L are attached to each other. The strain gauge type sensor 2 of this modification differs from the above embodiment only in the second lands. Thus, the other same components are denoted by the same reference numerals, respectively, and the description thereof will be omitted. Although FIG. 7 shows a section of one portion, the same applies to the other portions, and thus the description thereof will be omitted.

As shown in FIG. 7, in the strain gauge type sensor 2, each second land 281b on the flexible substrate 41 is vertically longer than that of the above embodiment. Thereby, a broader second land 281b can be ensured. This makes it easier to make electrical connection between the first land 71b and the lead wire L through the second land 281b. Also in this structure, the same effects as in the above embodiment are obtained.

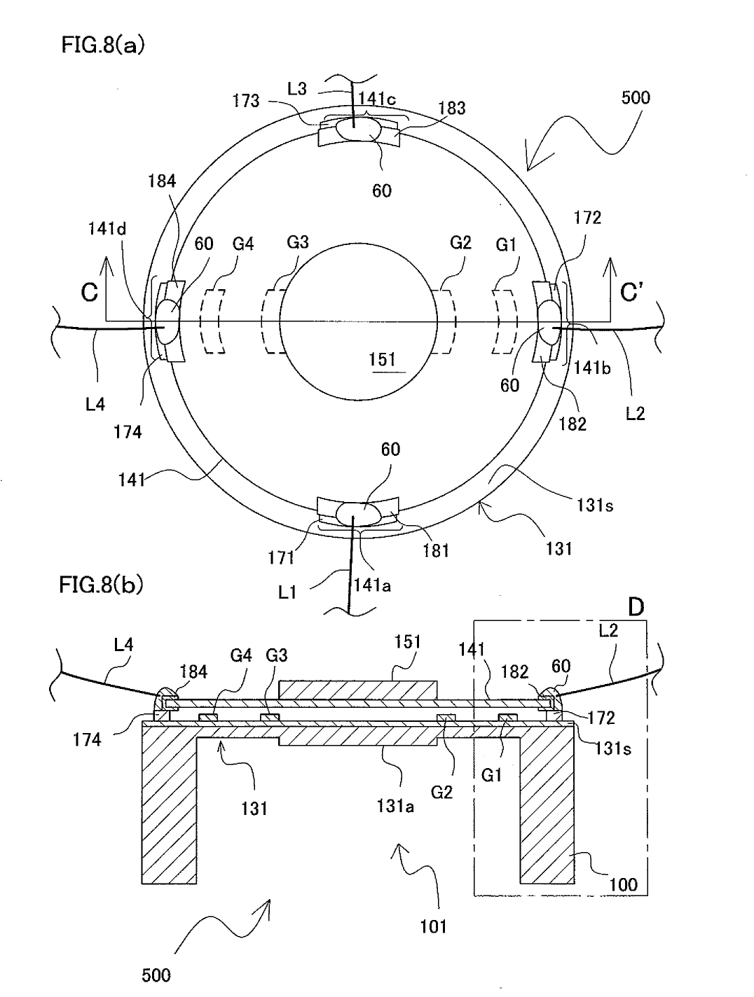

Next, a strain gauge type sensor according to a second embodiment of the present invention will be described with reference to FIGS. 8(a) and 8(b). FIG. 8(a) is an upper view of the strain gauge type sensor 500 of this embodiment. FIG. 8(b) is a C-C′ sectional view of FIG. 8(a).

Here will be described an embodiment in which the strain gauge type sensor 500 is used as a pressure sensor.

The strain gauge type sensor 500 includes a cylindrical portion 100 made of a metallic material such as SUS, and a disk diaphragm 131 also made of a metallic material. The diaphragm 131 is formed at one end of the cylindrical portion 100. The strain gauge type sensor 500 is for measuring a change in the pressure of gas or liquid introduced through an inlet opening 101 that is open at the other end of the cylindrical portion 100. As will be described later, strain gauges are disposed on the opposite surface of the diaphragm 131 from the inlet opening 101. A flexible substrate 141 is disposed over and fixed to the diaphragm 131 by soldering so as to cover the strain gauges. At a central portion of the surface of the diaphragm nearer to the inlet opening 101, a protrusion 131a is formed so that strains are efficiently generated in strain gauges G2 and G3. Lead wires L1 to L4 are connected to the strain gauge type sensor 500. In a modification, the cylindrical portion 100 and the diaphragm 131 may be made of not SUS but hastelloy or kovar.

The diaphragm 131 has, on its opposite surface from the inlet opening 101, an insulating film 131s made of silicon oxide or the like. The insulating film 131s is formed by sputtering or the like on the base body of the diaphragm 131 planarized in its whole area.

Four conductive first lands 171 to 174 are arranged around the central axis of the strain gauge type sensor 500 at angular intervals of 90 degrees. The first lands 171 to 174 are disposed at the same distance from the central axis. Each of the first lands 171 to 174 is made of a metallic thin film of nickel. The first lands 171 to 174 are formed on the surface of the insulating film 131s by sputtering, photolithography, and so on. For the first lands 171 to 174, gold, silver, cupper, chromium, or solder, can be used other than nickel.

Four strain gauges G1 to G4 are formed on the surface of the insulating film 131s in the form of a metallic thin film such as chromium, advance, constantan, a nichrome-base alloy, or chromium oxide, by sputtering, photolithography, and so on. The strain gauges G1 to G4 are arranged on a diameter of the diaphragm 131.

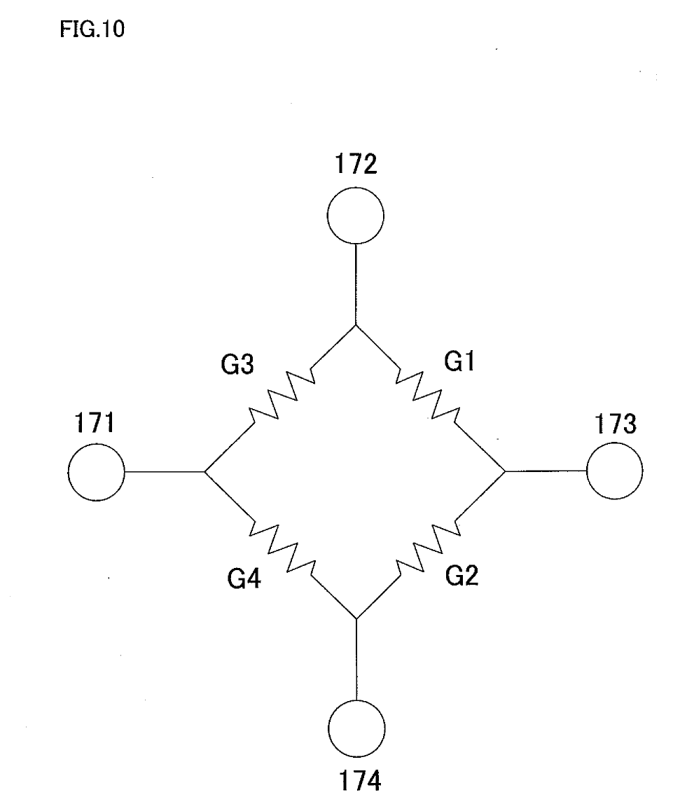

The strain gauges G6 to G4 constitute a bridge circuit as shown in FIG. 10, on the surface of the insulating film 131s so that strain generated in the diaphragm 131 can be detected as an electric signal with high sensitivity. The bridge circuit is also formed by sputtering, photolithography, and so on. The strain gauges G1 to G4 are electrically connected to the first lands 171 to 174. In order to supply a constant voltage or a constant current to the strain gauges G6 to G4 and receive an electric signal from the strain gauges G6 to G4, lead wires L1 to L4 are connected to the first lands 171 to 174 by soldering.

A flexible substrate 141 fixedly disposed on the diaphragm 131 is made of a synthetic resin material. As shown in FIGS. 8(a) and 8(b), four conductive second lands 181 to 184 are formed at the peripheral edge of the flexible substrate 141. The second lands 181 to 184 are arranged around the central axis of the strain gauge type sensor 500 at angular intervals of 90 degrees. The second lands 181 to 184 are disposed at the same distance from the central axis. Each of the second lands 181 to 184 is formed so as to extend from the surface of the flexible substrate 141 nearer to the diaphragm 131, to the opposite surface of the flexible substrate 141 farther from the diaphragm 131. In this embodiment, each of the second lands 181 to 184 is made of copper. For preventing oxidation, the second lands 181 to 184 may be plated with gold, silver, or solder. Portions of the flexible substrate 141 near the respective second lands 81a to 81d are referred to as substrate end portions 141a to 141d. The strain gauges G1 to G4 are disposed between the second lands 182 and 184.

A surface-mounted OP amplifier 151 is disposed in the middle of the flexible substrate 141. In this embodiment, because the OP amplifier 151 is installed in the strain gauge type sensor 500, the OP amplifier 151 is located near the output terminal of the bridge circuit. This lowers the output impedance, and makes it hard to receive adverse influence of a long lead wire.

As shown in FIG. 8(a), the substrate end portions 141a to 141d of the flexible substrate 141 near the respective second lands 181 to 184 are disposed above the first lands 171 to 174 of the diaphragm 131, respectively. The first lands 171 to 74 and the second lands 181 to 184 and the lead wires L1 to L4 are fixed to each other by soldering. Thus, the lead wires L1 to L4 are electrically connected to the respective strain gauges G1 to G4. In addition, the flexible substrate 141 is mechanically fixed to the diaphragm 131. By thus attaching the flexible substrate 141 to the diaphragm 131, the strain gauges G1 to G4 are covered by the flexible substrate 41.

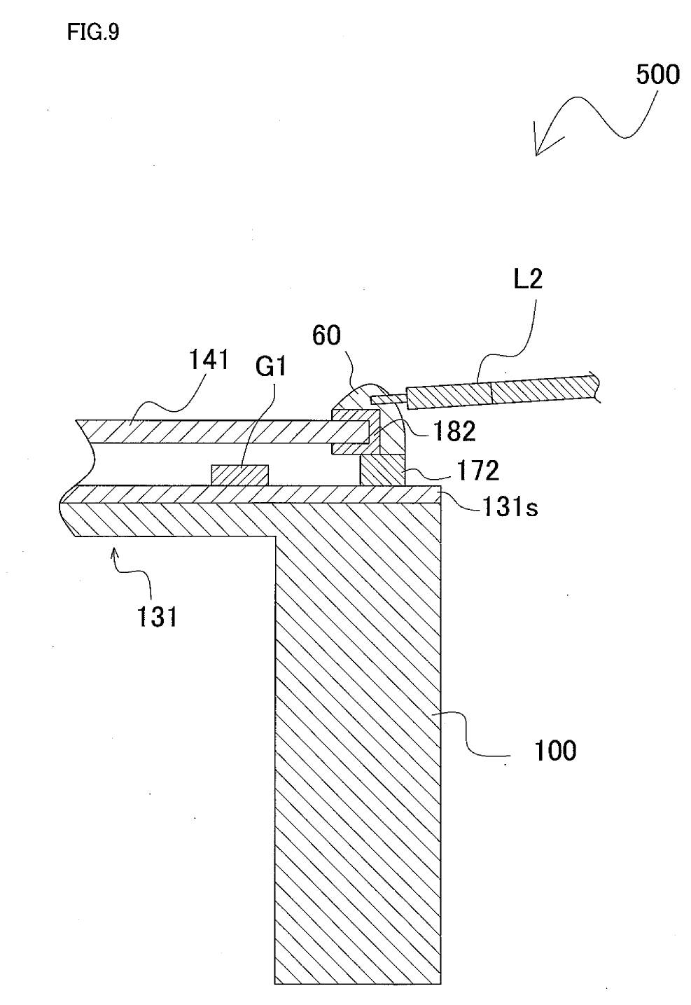

Next, a portion where the diaphragm 131, the flexible substrate 141, and the lead wire L2 are attached to each other, will be described with reference to FIG. 9. FIG. 9 is an enlarged sectional view of a region D in FIG. 8(b). The first lands 171 to 174 and the second lands 181 to 184 are in the same connection state. For this reason, FIG. 9 only shows a section including the first land 172 and the second land 182, and the description of the attachment portions of the first lands 171, 173, and 174 and the second lands 181, 183, and 184 will be omitted below.

As shown in FIG. 9, not only the first land 172 but also the second land 182 can be used for the land to which the lead wire L2 is attached. This increases the effective land area. Therefore, a strain gauge type sensor is obtained wherein the lead wire L2 can easily be attached.

For example, each strain gauge may be a piezoresistive element.

In the above embodiments, by way of example, a force sensor and a pressure sensor have been described. However, the present invention can be applied to another sensor than such a force or pressure sensor if the sensor is a strain gauge type sensor. For example, the technique of the present invention can be applied to an acceleration sensor, a load cell, and so on.

In the strain gauge type sensor 500, the diaphragm 131 is displaced only axially of the strain gauge type sensor 500. Therefore, when the thicknesses of the first lands 171 to 174 and the second lands 181 to 184 can keep the flexible substrate 141 at a proper distance from the strain gauges G1 to G4 on the diaphragm 131, the flexible substrate 141 may be a rigid substrate.

In the strain gauge type sensor 500, the protrusion 131a formed at the central portion of the surface of the diaphragm nearer to the inlet opening 101, may not be provided.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A strain gauge type sensor comprising:
a first plate-like member on which a strain gauge is disposed that detects a force externally applied;
a second plate-like member put in layers with the first plate-like member over a surface of the first plate-like member on which the strain gauge is disposed;
a conductive first connection region formed on the first plate-like member; and
a conductive second connection region formed near an end of the second plate-like member,
the first connection region, the second connection region, and a lead wire electrically connected to the strain gauge, being fixed by a conductive connection material in a state in which an end portion of the second plate-like member near the second connection region is disposed above the first connection region of the first plate-like member.

2. The strain gauge type sensor according to claim 1, wherein the first plate-like member comprises a pair of first connection regions, and the strain gauge disposed between the pair of first connection regions,
second connection regions are formed near both ends of the second plate-like member, and
the strain gauge is covered by the second plate-like member by fixing end portions of the second plate-like member near the respective second connection regions, on the pair of first connection regions of the first plate-like member, respectively.

3. The strain gauge type sensor according to claim 1, wherein a cutout is formed at an end of the second plate-like member, and
the second connection region is formed around the cutout.

4. The strain gauge type sensor according to claim 1, wherein the second connection region is smaller than the first connection region in heat capacity.
